(19) United States
(12) Patent Application Publication
(10) Pub. No.: US 2007/0123419 A1
(43) Pub. Date: May 31, 2007

(54) Activated carbon with improved mechanical resistance, and the uses thereof, especially as a catalyst carrier

(76) Inventor: Remy Le Bec, Labastide Cezerac (FR)

Correspondence Address: Millen White;Zelano & Branigan, Suite 1400, 2200 Clarendon Boulevard, Arlington, VA, 22201, US

(21) Appl. No.: 10/587,071

(22) PCT Filed: Jan. 19, 2005
(86) PCT No.: PCT/FR05/00114

§ 371 Date: Jul. 21, 2006

(30) Foreign Application Priority Data
Jan. 22, 2004 (FR) 0400568

(51) Int. Cl. C01B 31/08; B01J 21/18

(52) U.S. Cl. 502/416; 502/180; 502/182; 502/185

(57) ABSTRACT

The present invention relates to active charcoals with improved mechanical properties. They can advantageously be used in the sweetening of petroleum fractions, as oxidation catalyst support in the conversion of mercaptans to disulphides, but also in any other type of reaction, such as, for example, for the oxidation of cyanide present in water or in the synthesis of glyphosate, and in processes for purification and/or separation by selective adsorption in a liquid phase and/or in a gas phase (decolouration of liquid foodstuffs, water treatment, air treatment, recovery of solvents, and the like).

### TECHNICAL FIELD

The invention relates to an active charcoal which can be used in particular as catalyst support for reactions carried out in a liquid phase, in particular for oxidation reactions of mercaptans present in liquid hydrocarbons.

### PRIOR ART

The oxidation reaction of mercaptans present in liquid hydrocarbons consists in oxidizing the mercaptans present in hydrocarbons to disulphides by the action of a catalyst, generally sulphonated cobalt phthalocyanine, deposited on a porous solid support:
2RSH+½O₂→RSSR+H₂O

This reaction is catalysed in a basic medium (sodium hydroxide) using a catalyst based on cobalt phthalocyanine.

For heavy petroleum feedstocks (FCC petrol, kerosene, gas oil), use is made of a solid support for the catalyst in order to accelerate the reaction of the RSH compounds, which are heavier and therefore less reactive than the light RSH compounds.

Furthermore, as these mercaptans are heavier, they are not extracted from the organic phase. In this case, the level of sulphur does not change; the term used is then “sweetening” of the feedstock: conversion to disulphides, which are less corrosive than mercaptans. The main application is the production of jet fuel.

The paper entitled “Merox and Related Metal Phthalocyanine Catalyzed Oxidation Processes”, Basu et al., Catal. Rev. Sci. Eng., 35 (4), 571-609 (1993), is an extremely exhaustive compilation of the publications on this subject, from the viewpoint of the support, catalyst, doping additives, reaction mechanism, and the like. Numerous types of support are described therein: clays, aluminas, active charcoals, or any other solid support, but it is found that the supports made of carbonaceous material are often preferred. Publications teach that active charcoal is generally more efficient than the other supports from the viewpoint of catalytic kinetics of the reaction: cf. Oxidation of ethyl mercaptan over cobalt phthalocyanines, Huendorf U. et al., Heterog. Catal., 6(2), 73 (1987); Phthalocyanines on mineral carriers, 4a), Low-molecular-weight and polymeric phthalocyanines on SiO₂ and Al₂O₃ and active charcoal as catalysts for the oxidation of 2-mercaptoethanol, Wöhrle D. et al., Makromol. Chem., 190, 961-974 (1989).

In U.S. Pat. No. 4,248,694, UOP teaches that the use of a dense charcoal, with a bulk density of between 0.25 and 0.5 g/cm³, makes it possible to achieve better catalytic kinetics than less dense active charcoals. In the examples, UOP shows that the charcoal Darco MRX, with a density of 0.44 g/cm³, is a better candidate than the charcoal Nuchar WA, with a bulk density of 0.15 g/cm³.

In current industrial practice for the sweetening of hydrocarbons, only active charcoals are employed as catalyst supports.

The main processes for sweetening petroleum feedstocks or industrial hydrocarbons are known under the names of Merox (UOP technology), Mericat (Merichem technology) and Sulfrex (IFP technology):
the Merox technology developed by UOP, the principle of which is described in detail in U.S. Pat. No. 3,371,031, relates to the oldest and commonest process: it involves a simple fixed bed operated by percolation from the top downwards, followed by a hydrocarbon/sodium hydroxide knockout drum,
the Mericat technology developed more recently by Merichem. The system, the principle of which is set out in EP 203 574, has a fibre precontactor and then a bed of active charcoal operated in bottom upwards mode; the separator is integral with the column (which renders this unit more compact),
the Sulfrex technology developed by IFP, the principle of which is set out in Patent FR 2 560 889.

In these various sweetening processes, the active charcoal is placed in a column and then wetted under water. It is then impregnated with a dilute solution of catalyst, essentially based on sulphonated cobalt phthalocyanine, by circulating percolation through the column (until the desired degree of impregnation). This operation is generally carried out in situ in the column of the refinery. However, it can also be carried out ex situ, as indicated, for example, in: Merox Processes for caustic minimization and management, Holbrook et al. (UOP), NPRA 1993 Annual Meeting 1993.

Subsequently, the bed of active charcoal is completely impregnated with a sodium hydroxide solution (sodium hydroxide concentration: 5 to 20% by weight). Finally, the reaction can truly begin by simultaneous percolation of the hydrocarbon feedstock to be treated and of recycled sodium hydroxide solution, to which a minimum amount of air is added in order to carry out the reaction. The reaction is operated at moderate temperature and moderate pressure, namely approximately 20-80° C. and 0.1-1 MPa (1-10 bar) and preferably approximately 35-50° C. and 0.4-0.6 MPa (4-6 bar). The contact times vary from a few minutes to a few hours, preferably 30 to 60 min. The concentration of mercaptans, of a few hundred ppm at the inlet, changes to less than 30 ppm at the outlet of such a unit.

The industrial problems which may be encountered are rarely due to poor catalysis (i.e. inadequate degree of conversion of the RSH compounds to disulphides) - furthermore, in such a case, it is often sufficient to reimpregnate the support with the catalyst to restore good effectiveness—but rather to the mechanical strength of the active charcoal. This is because the latter is mechanically stressed, in particular when the hydrodynamic conditions are extreme (high rates of passage, massive flow rate, and the like), when the processing requires a layer of ceramic beads below the bed of active charcoal (Mericat process), resulting in an additional mechanical stress which the latter has to undergo, and the like. These conditions can damage the granules of active charcoal and form fines which, if they accumulate, produce a significant increase in the pressure drop of the industrial plant which can extend as far as forcing the latter to shut down in order to remove these fines, indeed even to completely change the charge of active charcoal, even if the catalyst was still effective.

As prolonged shutdowns in a refinery are expensive, it is obvious that it is necessary to limit these as much as possible. To remove fines and to change a charge of charcoal are unproductive operations which it is better to avoid. The operations of wetting but also of impregnating the charcoal with the catalyst are also unproductive operations which have to be carried out as rapidly as possible. A carbon even faster to wet and to impregnate will be more advantageous from this viewpoint.

Finally, in some cases, the hydrocarbon feedstock treated becomes coloured, a colouring probably due to side reactions which can be catalysed by the presence of impurities, such as iron oxides. It is therefore desirable for the support to comprise as little as possible in the way of impurities, in particular metal impurities.

### ACCOUNT OF THE INVENTION

The invention relates to active charcoals which do not exhibit the above disadvantages when they are used as catalyst support for reactions carried out in a liquid phase, in particular for oxidation reactions of mercaptans present in liquid hydrocarbons.

The reactive charcoals according to the invention are characterized by:
a total pore volume of greater than or equal to 1.00 ml/g, preferably of greater than or equal to 1.20 ml/g,
a bed strength (BS), measured according to a bulk crushing test from Shell, of greater than or equal to 1 MPa (10 bar) and preferably of greater than or equal to 1.5 MPa (15 bar) and advantageously of greater than or equal to 1.7 MPa (17 bar), and
a BET specific surface of greater than or equal to 500 m²/g, preferably of greater than or equal to 700 m²/g,

and, preferably,
the micropore volume of which, measured by nitrogen adsorption, is greater than or equal to 0.20 ml/g, preferably greater than or equal to 0.30 ml/g.
the mesopore volume of which, measured by nitrogen adsorption and mercury intrusion, is greater than or equal to 0.15 ml/g, preferably greater than or equal to 0.20 ml/g,
the macropore volume of which, measured by mercury intrusion, is greater than or equal to 0.40 ml/g, preferably greater than or equal to 0.50 ml/g.

In the present text, the definition of the micropore, mesopore and macropore volumes is in accordance with the IUPAC standard.

Advantageously, the active charcoals according to the invention have an iron content by weight of less than or equal to 2000 ppm (weight), preferably of less than or equal to 1000 ppm, advantageously of less than or equal to 500 ppm and more advantageously still of less than or equal to 300 ppm.

Among the active charcoals according to the invention, those which have a bulk density of between 0.20 and 0.50, preferably of between 0.3 and 0.4, are also preferred.

Among the active charcoals according to the invention, those which have an ash content (measured according to the CEFIC method) of less than or equal to 10%, preferably of less than or equal to 7%, of the total weight of the active charcoal before combustion at 650° C.

The particle size of the active charcoals according to the invention is generally such that the charcoal particles are retained by a sieve with a mesh size of 0.2 mm, preferably 0.4 mm and advantageously 0.6 mm, and pass through a sieve with a mesh size of 5 mm, preferably 2 mm.

The active charcoals according to the invention can be provided in various forms, such as:
strands, for example obtained by agglomeration of the starting carbonaceous raw material in the powder form with a binder of tar or pitch type, and the like, and then activation,
granules, for example obtained by crushing and sieving to the desired particle size pieces of activated active charcoals,
beads or any other shaping of particles, the particle size of which is preferably that described above.

Use is preferably made of active charcoals in the form of granules or of beads.

The active charcoals manufactured from sufficiently activated fruit stones, in particular those based on olive marc, exhibit the preferred characteristics of the invention: they are particularly strong mechanically, are rapidly impregnated with oxidation catalyst and exhibit low contents of inorganic impurities and they are therefore particularly suitable as supports for oxidation catalysts for particularly long periods of time.

Active charcoals based on fruit stones and advantageously based on olive marc can be manufactured according to conventional processes, that is to say either by physical activation or by chemical activation. The term “physical activation” is understood to mean a first stage of carbonization, generally at approximately 500° C., followed by a stage of activation with steam, generally at approximately 900° C.; the term “chemical activation” is understood to mean an impregnation of the carbonaceous raw material with a chemical agent, such as phosphoric acid or zinc chloride, followed by an activation, generally at approximately 500° C., followed by washing operations in order to recover the chemical agent used.

The present invention also relates to a process for the impregnation of these active charcoals with an oxidation catalyst and to the use of these supported catalysts for the oxidation of mercaptans in a liquid phase.

The active charcoals are impregnated with a metal complex which acts as oxidation catalyst; mention may be made, among the metal complexes, of cobalt, nickel, copper, zinc and vanadium phthalocyanines, metal complexes of polyaminoalkylpolycarboxylic acid, such as complexes of EDTA or of one of its salts, as disclosed, for example, in FR 2 560 889, or any other metal complex, cobalt phthalocyanine being particularly preferred.

The phthalocyanines are generally not directly soluble in aqueous solutions and for this reason it is preferable to use one of their water-soluble derivatives, such as the sulphonated and carboxylated derivatives, the sulphonated derivatives being preferred and, among these, the disulphonated derivatives being particularly advantageous.

It is also possible to add one or more promoting or doping additives disclosed in the literature, such as, for example, acetic acid or methanol (U.S. Pat. No. 4,087,378), urea (U.S. Pat. No. 4,098,681), a carboxylic acid (U.S. Pat. No. 4,107,078), ethanoltrimethylammonium chloride or hydroxide (U.S. Pat. Nos. 4,121,997 and 4,124,494), polynuclear aromatic sulphonic acid (U.S. Pat. No. 4,121,998), a quaternary ammonium (U.S. Pat. No. 4,157,312), alkanolamine hydroxide (U.S. Pat. No. 4,159,964), morpholine (U.S. Pat. No. 4,168,245) or monoethanolamine (U.S. Pat. No. 4,956,325).

This impregnation can be carried out either before or after placing the charcoal in the industrial unit in which the oxidation reaction of the mercaptans to disulphides is carried out.

Subsequently, the bed of active charcoal is completely impregnated with a basic solution, generally a sodium hydroxide solution (5 to 20% by weight of sodium hydroxide), a potassium hydroxide solution or an ammoniacal solution, as disclosed in U.S. Pat. No. 4,502,949 or U.S. Pat. No. 4,913,802.

Finally, the oxidation reaction of the mercaptans can truly begin, for example by simultaneous percolation of the hydrocarbon feedstock to be treated and of the recycled basic solution (sodium hydroxide solution, potassium hydroxide solution, ammoniacal solution, and the like), to which a minimum amount of air has been added in order to carry out the reaction. The latter is generally operated at moderate temperature and moderate pressure, namely approximately 20-80° C. and 0.1-1 MPa and preferably approximately 35-50° C. and 0.4-0.6 MPa. The contact times generally vary from a few minutes to a few hours, preferably 30 to 60 min. The concentration of mercaptans, of a few hundred ppm at the inlet, changes to less than 30 ppm at the outlet of such a unit.

The active charcoals based on fruit stones preferred by the Applicant Company have very good impregnation kinetics and are thus rapidly placed in position; their catalytic performances are equivalent to those of supports already known which are used industrially; as they have an excellent mechanical strength, the lifetime of the supported catalyst is increased with respect to those of the supports already used industrially; finally, as their iron contents are very low, the side reactions are very limited.

The active charcoals according to the invention can also be used as supports for catalysts in any other type of reaction, such as, for example, for the oxidation of cyanide present in water, as described in Chemical oxidation: Technologies for the Nineties, Kurek PR et al. (UOP), Proceedings First International Symposium, Nashville, 1993, or for the synthesis of glyphosate, for example disclosed in FR 2 269 533, as catalysts and in processes for purification and/or separation by selective adsorption in a liquid phase and/or in a gas phase (decoloration of liquid foodstuffs, water treatment, air treatment, recovery of solvents, and the like).

### WAYS OF CARRYING OUT THE INVENTION

Several active charcoals of different qualities and origins are compared and their main characteristics are listed in Table 1.

The characteristics of the charcoals are determined according to standard methods, in particular the CEFIC (Conseil Européen des Fédérations de l'Industrie Chimique [European Chemical Industry Council]) methods.

Two commercial charcoals conventionally used industrially as supports for a metallic oxidation catalyst for the sweetening of hydrocarbons: BGP MX, sold by Ceca, and Darco MRX, sold by Norit, were chosen for use by way of reference.

TABLE 1

| | | | | | | |
|---|---|---|---|---|---|---|
| Measurement | Trade name | BGP MX | — | NC35 | GAC 10-30 | Darco |
| method | | | | | | MRX |
| | Origin | Pine | Olive | Coconut | Coal | |
| | | wood | marc | | | |
| | Activation | Physical | Physical | Physical | Physical | |
| | Bulk | 0.20 | 0.39 | 0.51 | 0.50 | 0.40 |
| | density | | | | | |
| | (g/cm³) | | | | | |
| CEFIC | Iodine | 680 | 850 | 1000 | 1000 | 510 |
| | number | | | | | |
| CEFIC | Methylene | 4 | 6 | 6 | 8 | 7 |
| | blue | | | | | |
| | number | | | | | |
| CEFIC | Ash | 2.5 | 3.1 | 4.8 | 11.3 | 13.7 |
| | content (% | | | | | |
| | by weight) | | | | | |
| — | Iron | 70 | 200 | 150 | 4000 | 2000 |
| | content | | | | | |
| | (ppmw) | | | | | |
| Nitrogen | BET | 760 | 870 | 1150 | 1050 | 560 |
| adsorption | specific | | | | | |
| | surface | | | | | |
| | (m²/g) | | | | | |
| Nitrogen | Total pore | 0.835 | 1.341 | 0.724 | 0.916 | 0.936 |
| adsorption + mercury | volume | | | | | |
| intrusion | (ml/g) | | | | | |
| Nitrogen | Micropore | 0.236 | 0.360 | 0.430 | 0.400 | 0.173 |
| adsorption | volume | | | | | |
| | <20 Å | | | | | |
| | (ml/g) | | | | | |
| Nitrogen | Mesopore | 0.06 | 0.05 | 0.02 | 0.12 | 0.11 |
| adsorption | volume 20 Å-70 Å | | | | | |
| | (ml/g) | | | | | |
| Mercury | Mesopore | 0.084 | 0.210 | 0.100 | 0.130 | 0.310 |
| intrusion | volume 70 Å-500 Å | | | | | |
| | (ml/g) | | | | | |
| Mercury | Macropore | 0.455 | 0.721 | 0.174 | 0.266 | 0.343 |
| intrusion | volume | | | | | |
| | 500 Å - | | | | | |
| | 10 μm | | | | | |
| | (ml/g) | | | | | |

Specific tests were developed to demonstrate the properties of the active charcoals tested as oxidation catalyst supports.

### EXAMPLE 1

Bed Strength Test

This test makes it possible to measure the mechanical strength of a bed of solid particles which are subjected to an evenly distributed pressure. It draws its inspiration from a Shell bulk crushing strength test. 20 cm³ of adsorbent are placed in a metal cylinder with an internal diameter of 27.6 mm. A pressure which increases in stationary phases is applied to the top of the bed via a piston. Between each stationary phase, the level of fines (<0.2 mm) formed is determined by sieving and weighing. The pressure necessary to obtain 0.5% by weight of fines is subsequently deduced therefrom by interpolation.

The results are given in the following Table 2:

TABLE 2
Bed strength of the active charcoals

| | | | | | |
|---|---|---|---|---|---|
| Trade name | BGP MX | — | NC35 | GAC 10-30 | Darco MRX |
| Origin | Pine wood | Olive | Coconut | Coal | |
| | | marc | | | |
| Pressure (MPa) | 0.25 | 2.14 | 1.56 | 1.55 | 1.00 |
| such as 0.5% | | | | | |
| fines | | | | | |

It is clearly apparent that the active charcoal according to the invention based on olive marc is the strongest mechanically and markedly above the two charcoals used industrially in this application.

### EXAMPLE 2

Test of Impregnation Kinetics of the Catalyst

A catalyst solution comprising 30% of sulphonated cobalt phthalocyanine, sold by Europhtal under the name 802, is used.

320 ml of active charcoal are introduced into 1 litre of water in a beaker. A small amount of ammoniacal solution is added, such that the pH of this final solution after addition of the ammoniacal solution is greater than or equal to 9. A dose of Europhtal 802 catalyst is subsequently introduced such that the final product has a dose of exactly 2 g of catalyst per litre of active charcoal. The mixture is gently stirred and samples are taken spaced out over time. The amount of catalyst still present in the solution is assayed. This assaying can be carried out by an optical density measurement at the wavelength of 660 nm, after precalibration of the apparatus.

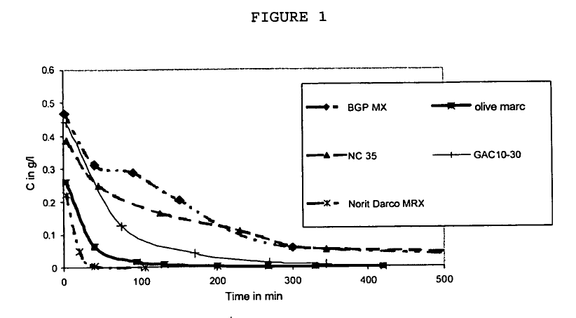

The results are given in the following FIG. 1.

It is seen that the active charcoal according to the invention based on olive marc and Darco MRX are impregnated more rapidly than the others. Those based on wood and on coconut are the slowest, their impregnation still not being complete after 500 min.

### EXAMPLE 3

Catalytic Test of Oxidation of Mercaptan

This test draws its inspiration from works such as: Oxidation of ethyl mercaptan over cobalt phthalocyanines, Huendorf U. et al., Heterog. Catal., 6(2), 73 (1987).

0.5 ml of active charcoal, preimpregnated with catalyst according to the test of Example 2 (i.e. 2 g of catalyst/litre of charcoal), 50 ml of sodium hydroxide solution (concentration: 7% by weight) and 140 g of n-heptane comprising 2.81 g of t-butyl mercaptan are successively introduced into a 0.5 litre glass reactor maintained at ambient temperature by a jacket. Stirring adjusted to 500 revolutions/min is begun and an air flow controlled at 1 litre/h is introduced by sparging into the solution.

Samples of the organic phase are taken spread out over time in order to monitor the residual mercaptan concentration. The mercaptan is assayed by chromatography.

The initial RSH content is 20,000 ppm by weight.

The results are given in the following Table 3:

TABLE 3
Kinetics of oxidation of the mercaptans

| | | | | | |
|---|---|---|---|---|---|
| Trade name | BGP MX | — | NC35 | GAC 10-30 | Darco |
| | | | | | MRX |
| Origin | Pine | Olive | Coconut | Coal | |
| | wood | marc | | | |
| RSH content after | 4420 | 4950 | 8460 | 5010 | 4660 |
| 60 min (ppm by | | | | | |
| weight) | | | | | |
| RSH content after | 1500 | 1700 | 7070 | 3200 | 1300 |
| 120 min (ppm by | | | | | |
| weight) | | | | | |
| RSH content after | 140 | 76 | 6130 | 1220 | 120 |
| 180 min (ppm by | | | | | |
| weight) | | | | | |
| RSH content after | 32 | 33 | 4330 | 140 | 34 |
| 360 min (ppm by | | | | | |
| weight) | | | | | |

It is noted that three charcoals (BGP MX, Darco MRX and the active charcoal according to the invention based on olive marc) exhibit more or less equivalent catalytic performances. Furthermore, the other two charcoals, which exhibited appreciable mechanical strengths (GAC 10-30 and NC 35), have catalytic kinetics which are markedly slower in comparison with these.

It is apparent that only the active charcoal manufactured from olive marc exhibits the optimum characteristics, namely: particularly strong mechanically, rapidly impregnated, with an excellent catalytic performance and exhibiting low contents of inorganic impurities, in particular iron.

1. Active charcoal, characterized by:
a total pore volume of greater than or equal to 1.00 ml/g, preferably of greater than or equal to 1.20 ml/g,
a bed strength (BS), measured according to a bulk crushing test from Shell, of greater than or equal to 1 MPa (10 bar) and preferably of greater than or equal to 1.5 MPa (15 bar) and advantageously of greater than or equal to 1.7 MPa (17 bar), and
a BET specific surface of greater than or equal to 500 m²/g, preferably of greater than or equal to 700 m²/g.

2. Active charcoal according to claim 1, characterized in that it exhibits:
a micropore volume, measured by nitrogen adsorption, of greater than or equal to 0.20 ml/g, preferably of greater than or equal to 0.30 ml/g.
a mesopore volume, measured by nitrogen adsorption and mercury intrusion, of greater than or equal to 0.15 ml/g, preferably of greater than or equal to 0.20 ml/g, and
a macropore volume, measured by mercury intrusion, of greater than or equal to 0.40 ml/g, preferably of greater than or equal to 0.50 ml/g.

3. Active charcoal according to claim 1, characterized in that its iron content by weight is less than or equal to 2000 ppm, preferably less than or equal to 1000 ppm, advantageously less than or equal to 500 ppm and more advantageously still less than or equal to 300 ppm.

4. Active charcoal according to claim 1, characterized in that its bulk density is between 0.20 and 0.50, preferably between 0.3 and 0.4.

5. Active charcoal according to claim 1, characterized in that its ash content is less than or equal to 10%, preferably less than or equal to 7%, of the total weight of the active charcoal.

6. Active charcoal according to claim 1, characterized in that its particle size is such that the charcoal particles are retained by a sieve with a mesh size of 0.2 mm, preferably 0.4 mm and advantageously 0.6 mm, and pass through a sieve with a mesh size of 5 mm, preferably 2 mm, and are provided in the form of strands, preferably in the form of granules or beads.

7. Active charcoal according to claim 1, characterized in that it is based on fruit stones, preferably based on olive marc.

8. Process for the impregnation of active charcoal as defined in claim 1:
a) with an aqueous solution of a metal complex chosen from cobalt, nickel, copper, zinc and vanadium phthalocyanines, metal complexes of polyaminoalkylpolycarboxylic acid, such as complexes of EDTA or of one of its salts, preferably cobalt phthalocyanine, and optionally one or more promoting or doping additives, and
b) by impregnation with a basic solution, for example based on sodium hydroxide, potassium hydroxide or ammonia.

9. Catalyst for the oxidation of mercaptans to disulphides, characterized in that it is composed of at least one metal complex, such as a cobalt, nickel, copper, zinc or vanadium phthalocyanine, preferably cobalt phthalocyanine, or one metal complex of polyaminoalkylpolycarboxylic acid attached to an active charcoal as defined in claim 1.

10. Catalyst for the oxidation of mercaptans according to claim 9, characterized in that it is capable of being obtained according to the impregnation process of this invention, it being understood that the impregnation stage b) can take place during the reaction for the oxidation of the mercaptans.

11. Use of an active charcoal as defined in claim 1 as catalyst support, in particular for the oxidation of cyanide present in water or the synthesis of glyphosate.

12. Use of an active charcoal as defined in claim 1 as catalyst.

13. Use of an active charcoal as defined in claim 1 in processes for purification and/or separation by selective adsorption in a liquid phase and/or in a gas phase (decolouration of liquid foodstuffs, water treatment, air treatment, recovery of solvents, and the like).
